(19) United States
(12) Patent Application Publication
(10) Pub. No.: US 2026/0054850 A1
(43) Pub. Date: Feb. 26, 2026

(54) DATA TRANSMISSION ARCHITECTURE AND VEHICLE FITTED WITH SUCH ARCHITECTURE

(71) Applicant: AIRBUS HELICOPTERS, Marignane Cedex (FR)

(72) Inventors: Clément LETONNELIER, La Fare Les Oliviers (FR); Pascal IZZO, Berre L'etang (FR)

(73) Assignee: AIRBUS HELICOPTERS, Marignane Cedex (FR)

(21) Appl. No.: 19/210,691

(22) Filed: May 16, 2025

(30) Foreign Application Priority Data
Aug. 22, 2024 (FR) FR2409057

(51) Int. Cl. B64D 47/00; H04L 12/40

(52) U.S. Cl. CPC B64D 47/00; H04L 12/40

(57) ABSTRACT

An architecture for transmitting data within an avionics system fitted to a vehicle, the architecture comprising a first field bus and a first avionics bus. According to the invention, the architecture comprises at least two primary channels each comprising: a primary field interface enabling communication between each primary channel via the first field bus, the field interfaces being interconnected with the first field bus; and a first avionics interface compatible with the first avionics bus. The architecture comprises at least one primary computer provided with a second avionics interface in communication via the first avionics bus with only one first avionics interface among the first avionics interfaces.

### CROSS REFERENCE TO RELATED APPLICATIONS

This application claims priority to French patent application No. FR 24 09057 filed on Aug. 22, 2024, the disclosure of which is incorporated in its entirety by reference herein.

### TECHNICAL FIELD

The present disclosure relates to a data transmission architecture and to a vehicle, such as an aircraft, provided with this architecture for transmitting data within an avionics system of the vehicle.

### BACKGROUND

More particularly, the disclosure relates to the field of system architectures for the transmission of critical data between avionics equipment and a computer mounted on vehicles.

In general, such architectures comprise one or more buses having at least one link for transmitting this data between each piece of avionics equipment and a computer configured to execute at least one critical function of the avionics system.

Document EP4236268 thus discloses a method and a system for transferring data on an avionics bus. In particular, such an avionics bus comprises a large number of connections between each piece of avionics equipment and a computer.

Document US2007127521 describes an avionics bus interface in particular suitable for communicating according to a communication protocol via an Ethernet bus or an avionics bus as designated by the expression “Avionics Full Duplex” or its acronym “AFDX”.

However, such a communication protocol is expensive and cumbersome to implement for all the electronic equipment of an aircraft, but also expensive and cumbersome to implement for a limited number of critical pieces of equipment of an aircraft.

Document WO0237791A1 discloses a secure field bus system having, as transmission medium, an open communication channel, that is also accessible to avionics equipment using other communication connections. This may comprise, in particular, an existing standardized in-line connection, such as an Ethernet connection of an existing computer network, or a radio connection.

Finally, document U.S. Pat. No. 6,003,146A discloses a method for detecting errors in aircraft data periodically transmitted through an avionics data bus from a transmitting unit to a receiving unit.

Document US20100075614 D1 relates to an avionics communication unit that comprises at least one port according to a first type, at least one port according to a second type and a communication function. The first type ports are configured to enable a communication link using a first communication format with the communication unit. The second type ports are configured to enable a communication link using a second communication format with the communication unit.

Such a communication unit can provide communications to and from an aircraft. In particular, the communication unit comprises a link unit between a field bus (Ethernet) and an avionics bus (ARINC 429).

Document EP2309682 discloses a frame switching device that is far from the disclosure.

### SUMMARY

An object of the present disclosure is therefore to propose an innovative alternative architecture that can overcome the above-mentioned limitations. In addition, with a conventional architecture, each piece of equipment is connected to the computer. The system may thus have a non-negligible mass. The aim of the disclosure is to obtain a safe and inexpensive system that overcomes this disadvantage.

Thus, the disclosure relates to an architecture for transmitting data within an avionics system fitted to a vehicle, such as an aircraft, the architecture comprising a first field bus and a first avionics bus, the first avionics bus being distinct from the first field bus.

The architecture comprises:
at least two primary channels, each comprising:
a primary field interface, the field interfaces being interconnected with the first field bus;
a first avionics interface compatible with the first avionics bus;
a primary processing unit generating primary uplink avionics data frames;
at least one primary conversion unit converting each primary uplink avionics data frame generated by the primary processing unit into at least one primary uplink field data frame intended to be transmitted via the first field bus to each of the other primary channels and, conversely, converting each primary uplink field data frame received via the first field bus into a primary uplink avionics data frame; and
a primary memory storing a set of primary uplink avionics data frames comprising the primary uplink avionics data frames generated by each of the primary processing units of the at least two primary channels.

Moreover, the architecture comprises at least one primary computer provided with a second avionics interface in communication via the first avionics bus with only one first avionics interface among the first avionics interfaces of the at least two primary channels, the other first avionics interfaces being left free and separate from any avionics bus, the at least one primary computer receiving the set of primary uplink avionics data frames via the first avionics bus and being configured to execute at least one critical function of the avionics system, using at least one of the primary uplink avionics data frames of the set of primary uplink avionics data frames.

In addition, the expression “primary processing unit” may include, for example, at least one processor, at least one integrated circuit, at least one programmable system, and at least one logic circuit, these examples not limiting the scope given to the expression “primary processing unit”. The term “processor” may refer equally to a central processing unit or CPU, a graphics processing unit or GPU, a digital signal processor or DSP, a microcontroller, etc.

Each primary channel thus designates an entity independent of a computer or piece of equipment. In addition to a primary processing unit and primary memory, each primary channel may comprise an acquisition and control interface and an electrical power supply.

In addition, the primary channels may or may not be synchronized with one another to carry out the transmission of the primary uplink field data frames through the first field bus.

Furthermore, the expression “primary uplink field data frame” designates a basic structure of a set of data exchanged via the first field bus. This structure is framed by start and end bits. It is therefore generally composed of a header, the data that it is desired to transmit in the first field bus, and a postamble. It is called “uplink” because it relates to the data exchanged between the at least two primary channels and then going on to the avionics computer as opposed to downlink data sent by the avionics computer to the at least two primary channels.

Similarly, the expression “primary uplink avionics data frame” designates another basic structure of a set of data exchanged via the first avionics bus. This other structure is framed by start and end bits. It is therefore generally composed of a header, the data that it is desired to transmit in the first avionics bus, and a postamble.

Cyclically, the primary conversion unit of each primary channel can prepare the primary uplink avionics data frames and then store them in the primary memory in a transmission queue of primary uplink avionics data frames.

The primary conversion unit may then encapsulate each primary uplink avionics data frame in one or more primary uplink field data frames, and transmit them by means of a primary field interface on the first field bus.

Upon receipt of a primary uplink field data frame by the other primary channels, their primary conversion unit de-encapsulates the primary uplink avionics data frames contained therein and stores them in their respective primary memory in their transmission queue of the primary uplink avionics data frames.

Consequently, the first field bus enables the transmission between each primary channel of the primary uplink avionics data frames from all the primary channels.

The first field bus thus makes it possible to store all the primary uplink avionics data frames in each primary memory, a single first avionics interface being connected to the first avionics bus in order to transmit all the primary uplink avionics data frames to the primary computer.

Such an architecture thus comprises a single first avionics bus for all the primary channels. The architecture therefore has a minimal number of links or connections. The architecture comprises a single link on the first avionics bus linking a first avionics interface and the second avionics interface of the primary computer receiving the set of the primary uplink avionics data frames. Similarly, the primary computer comprises a single second avionics interface for receiving all primary uplink avionics data frames.

In addition, such a single link on the first avionics bus may be provided between any of the first avionics interfaces of said at least two primary channels and the second avionics interface of the primary computer.

The number of primary uplink field data frames required to transmit the primary uplink avionics data frames on the field bus may depend on the type of field bus used.

In addition, the number of primary uplink avionics data frames stored in each primary memory may depend on the implementation and occupancy balance of the first avionics bus and the first field bus.

Only one of a plurality of primary channels can transmit the primary uplink avionics data frames by means of its first avionics interface, as long as primary uplink avionics data frames are available in the transmission queue and as long as the latter is not empty.

In addition, and according to a first embodiment of the disclosure, the architecture may be of the simplex type and comprise only primary channels. In this case, the architecture comprises a single field bus formed by said first field bus and a single avionics bus formed by said first avionics bus.

According to a first example of simplex architecture, the architecture may comprise at least one piece of equipment comprising at least two primary channels from among said at least two primary channels.

According to a first variant, the architecture may comprise a single piece of equipment comprising a plurality of field interfaces connected to one another via the first field bus and, for example, a single first avionics interface compatible with the first avionics bus.

In this case, the first field bus can be entirely part of the single piece of equipment of the architecture.

According to a second variant, the architecture may comprise a plurality of pieces of equipment, each of the pieces of equipment then comprising a plurality of primary field interfaces connected to one another via the first field bus. On the other hand, only one of the pieces of equipment may be connected to the first avionics bus by means of a first avionics interface.

According to a second example of simplex architecture, the architecture may comprise at least two pieces of equipment, each piece of equipment comprising only one of said at least two primary channels.

Consequently, when said at least two primary channels comprise a first primary channel and a second primary channel, the architecture may comprise a first piece of equipment comprising exclusively the first primary channel and a second piece of equipment comprising exclusively the second primary channel.

In other words, the first piece of equipment may comprise a first primary field interface and the second piece of equipment may comprise a second primary field interface. These first and second field interfaces are then connected to each other via the first field bus.

Only the first piece of equipment may then be connected to the first avionics bus by means of a first avionics interface. The avionics interface corresponding to the second primary channel of the second equipment is thus left free.

In this case, the first field bus can be both internal and external to the architecture equipment.

Advantageously, said at least one primary uplink field data frame received via the first field bus and/or the set of primary uplink avionics data frames can be transmitted by means of electrical or optical signals.

In other words, the first field bus and/or the first avionics bus may comprise at least one electrically conductive element, such as a copper wire, or at least one optical fiber for transmitting said at least one primary uplink field data frame and/or the set of primary uplink avionics data frames.

In practice, the first field bus may be selected among the group comprising a CAN bus, a CAN-FD bus, a LIN bus, a bus according to standard EIA-485, a bus according to standard EIA-422, a FlexRay bus, an Ethernet bus, an EtherCAT bus, a DeviceNet bus, a CANOpen bus, a CANOpen FD bus, a MODBUS bus, a PROFIBUS bus and a PROFINET bus.

Furthermore, said at least one primary uplink field data frame and/or the set of the primary uplink avionics data frames received via the first avionics bus may be transmitted by means of electrical or optical signals.

In other words, the first field bus and/or the first avionics bus may comprise at least one electrically conductive element, such as a copper wire, or at least one optical fiber enabling the transmission of said at least one primary uplink field data frame and/or of the set of the primary uplink avionics data frames between the first avionics interface and the second avionics interface.

Advantageously, the first avionics bus may be selected from the group comprising a bus according to standard STANAG 3910, a bus according to standard ARINC 429, a bus according to standard MIL-STD-1553B, a bus according to standard ARINC 629, a bus according to standard EIA-485, a bus according to standard EIA-422, an Ethernet bus and a bus according to standard ARINC-664.

According to a second embodiment of the disclosure, the architecture may be of the duplex type and may comprise, in addition to the first field bus, the first avionics bus and the primary channels:
a second field bus, the second field bus being separate from the first field bus and the first avionics bus;
a second avionics bus, the second avionics bus being separate from the first field bus, the first avionics bus and the second field bus;
at least two secondary channels distinct from said at least two primary channels, said at least two secondary channels each comprising:
a secondary field interface, the secondary field interfaces being interconnected to the second field bus;
a third avionics interface compatible with the second avionics bus;
a secondary processing unit generating secondary uplink avionics data frames;
at least one secondary conversion unit converting each secondary uplink avionics data frame generated by the secondary processing unit into at least one secondary uplink field data frame intended to be transmitted via the first field bus to each of the other secondary channels and, conversely, converting each secondary uplink field data frame received via the first field bus into a secondary uplink avionics data frame; and
a secondary memory storing a set of secondary uplink avionics data frames comprising the secondary uplink avionics data frames generated by each of the secondary processing units of said at least two secondary channels.

Moreover, the architecture may comprise at least one secondary computer provided with a fourth avionics interface in communication via the second avionics bus with only one third avionics interface among the third avionics interfaces of said at least two secondary channels, the other third avionics interfaces being left free and separate from any avionics bus, said at least one secondary computer receiving the set of secondary avionics data frames via the second avionics bus and being configured to execute at least one critical function of the avionics system using at least one of the secondary uplink avionics data frames of the set of secondary uplink avionics data frames.

In addition, the expression “secondary processing unit” may include, for example, at least one processor, at least one integrated circuit, at least one programmable system, and at least one logic circuit, these examples not limiting the scope given to the expression “secondary processing unit”. The term “processor” may refer equally to a central processing unit or CPU, a graphics processing unit or GPU, a digital signal processor or DSP, a microcontroller, etc.

Furthermore, each secondary channel designates an entity independent of a computer or piece of equipment. In addition to a secondary processing unit and secondary memory, each secondary channel may comprise an acquisition and control interface and an electrical power supply.

In addition, the secondary channels may or may not be synchronized with one another to carry out the transmission of the secondary uplink field data frames through the second field bus.

Furthermore, the expression “secondary uplink field data frame” designates a basic structure of a set of data exchanged via the second field bus. This structure is framed by start and end bits. It is therefore generally composed of a header, the data that it is desired to transmit in the second field bus, and a postamble.

Similarly, the expression “secondary uplink avionics data frame” designates another basic structure of a set of data exchanged via the second avionics bus. This other structure is framed by start and end bits. It is therefore generally composed of a header, the data that it is desired to transmit in the second avionics bus, and a postamble.

Cyclically, the secondary conversion unit of each secondary channel can prepare the avionics data frames and then store them in the secondary memory at a transmission queue of the secondary uplink avionics data frames.

The secondary conversion unit may then encapsulate each secondary uplink avionics data frame in one or more secondary uplink field data frames and transmit them by means of a secondary field interface on the second field bus.

As soon as a secondary uplink field data frame is received by the other secondary channels, their secondary conversion unit de-encapsulates the secondary uplink avionics data frames it contains and stores them in their respective secondary memory at the level of their transmission queue of the secondary uplink avionics data frames.

Consequently, the second field bus enables the transmission between each secondary channel of the secondary uplink avionics data frames from all the secondary channels.

The second field bus thus makes it possible to store all the secondary uplink avionics data frames in each secondary memory, a single third avionics interface being connected to the second avionic bus in order to transmit the set of secondary uplink avionics data frames to the secondary computer.

In addition, the secondary computer may be separate from or combined with the primary computer. Similarly, the at least one critical function of the avionics system implemented by the secondary computer may be distinct from or identical to the at least one critical function of the avionics system implemented by the primary computer.

Consequently, such an architecture comprises a single second avionics bus for all the secondary channels. The architecture therefore has a minimal number of links or connections. The architecture thus comprises a single connection on the second avionics bus linking a third avionics interface and the fourth avionics interface of the secondary computer receiving the set of secondary uplink avionics data frames. Similarly, the secondary computer comprises a single fourth avionics interface for receiving all of the secondary uplink avionics data frames.

In addition, such a single link on the second avionics bus may be provided between any of the third avionics interfaces of said at least two secondary channels and the fourth avionics interface of the secondary computer.

The number of secondary field data frames required to transmit the avionics frames on the second field bus may depend on the type of field bus used.

In addition, the number of secondary avionics data frames stored in each secondary memory may depend on the implementation and occupancy balance of the second avionics bus and the second field bus.

Only one of a plurality of secondary channels can transmit the secondary uplink avionics data frames by means of its third avionics interface, as long as secondary uplink avionics data frames are available in the transmission queue and as long as the latter is not empty.

According to a first example of duplex architecture, the architecture may comprise at least one piece of equipment, each piece of equipment comprising each of said at least two primary channels and said at least two secondary channels.

In a first alternative, a single piece of equipment may comprise a plurality of field interfaces connected to one another via the first field bus and via the second field bus, respectively.

This single piece of equipment may also comprise a single first avionics interface connected to the first avionics bus and a single third avionics interface connected to the second avionics bus.

The first field bus and the second field bus can in this case be part of the unique equipment of the architecture.

According to a second alternative, the architecture may comprise a plurality of pieces of equipment, each of the pieces of equipment then comprises a plurality of primary field interfaces connected to one another via the first field bus and a plurality of secondary field interfaces connected to one another via the second field bus. One of the pieces of equipment may comprise the first avionics interface compatible with the first avionics bus, and another piece of equipment may comprise the third avionics interface compatible with the second avionics bus.

In this case, the first and second field buses may be part of the at least two pieces of equipment of the architecture.

According to a second example of duplex architecture, the architecture may comprise at least two pieces of equipment, each piece of equipment comprising only one of said at least two primary channels and only one of said at least two secondary channels.

In other words, a first piece of equipment may comprise first primary and secondary field interfaces corresponding to each of the first primary and secondary channels. The second piece of equipment may comprise second primary and secondary field interfaces corresponding to each of the first primary and secondary channels. These first and second primary and secondary field interfaces are then respectively connected to one another via the first field bus and via the second field bus.

Only the first piece of equipment can then comprise the first avionics interface compatible with the first avionics bus. Similarly, in order to provide a minimal duplex architecture, only the second piece of equipment can comprise the third avionics interface compatible with the second avionics bus.

In this case, the first and second field buses may be external to the equipment of the architecture.

Advantageously, said at least one secondary uplink field data frame received via the first field bus, and/or the set of primary uplink avionics data frames, can be transmitted by means of electrical or optical signals.

In other words, the second field bus and/or the second avionics bus may comprise at least one electrically conductive element, such as a copper wire, or at least one optical fiber for transmitting said at least one secondary uplink field data frame and/or the set of primary uplink avionics data frames.

In practice, the second field bus may be distinct from the first field bus and the first avionics bus, the second field bus being selected from the group comprising a CAN bus, a CAN-FD bus, a LIN bus, a bus according to standard EIA-485, a bus according to standard EIA-422, a FlexRay bus, an Ethernet bus, an EtherCAT bus, a DeviceNet bus, a CANOpen bus, a CANOpen FD bus, a MODBUS bus, a PROFIBUS bus and a PROFINET bus.

Furthermore, said at least one secondary uplink field data frame received via the second field bus, and/or the set of said secondary avionics data frames received via the second avionics bus, may be transmitted by means of electrical or optical signals.

In other words, the second field bus and/or the second avionics bus may comprise at least one electrically conductive element, such as a copper wire, or at least one optical fiber enabling the transmission of said at least one secondary uplink field data frame and/or of the set of secondary uplink avionics data frames, between the third avionics interface and the fourth avionics interface.

In addition, the second avionics bus may be selected from the group comprising a bus according to standard STANAG 3910, a bus according to standard ARINC 429, a bus according to standard MIL-STD-1553B, a bus according to standard ARINC 629, a bus according to standard EIA-485, a bus according to standard EIA-422, an Ethernet bus and a bus according to standard ARINC-664.

The disclosure also relates to an architecture for transmitting data within an avionics system fitted to a vehicle, the architecture comprising a first field bus and a first avionics bus, the first avionics bus being distinct from the first field bus.

According to the disclosure, such an architecture comprises:
at least two primary channels, each comprising:
a primary field interface, the field interfaces being interconnected with the first field bus;
a first avionics interface compatible with the first avionics bus;
at least one primary computer provided with a second avionics interface in communication via said first avionics bus with only one first avionics interface among the first avionics interfaces of said at least two primary channels, the other first avionics interfaces being left free and separate from any avionics bus, said at least one primary computer transmitting at least one primary downlink avionics data frame via said first avionics bus;
said at least two primary channels each comprising:
a primary processing unit using said at least one primary downlink avionics data frame;
at least one primary conversion unit converting said at least one primary downlink avionics data frame transmitted by said at least one primary computer into at least one primary downlink field data frame intended to be transmitted via said first field bus to each of the other primary channels and, conversely, converting each primary downlink field data frame received via the first field bus into a primary downlink avionics data frame; and
a primary memory storing a set of primary downlink avionics data frames.

As previously, such an architecture may be of various kinds and in particular may be implemented according to the first embodiment by being of the simplex type, or according to the second embodiment by being of the duplex type.

Furthermore, the expression “primary downlink avionics data frame” designates a basic structure of a set of data exchanged, via the first avionic bus, from said at least one primary computer to the at least two primary channels.

Similarly, the expression “primary downlink field data frame” designates another basic structure of a set of data exchanged via the first field bus. This structure is called “downlink” because it relates to the data transmitted by the avionics computer to the at least two primary channels.

In addition, and according to a first embodiment of the disclosure, the architecture may be of the simplex type and comprise only primary channels. In this case, the architecture comprises a single field bus formed by said first field bus and a single avionics bus formed by said first avionics bus.

According to a second embodiment of the disclosure, the architecture may be of the duplex type and may comprise, in addition to the first field bus, the first avionics bus and the primary channels:
a second field bus, the second field bus being separate from the first field bus and the first avionics bus;
a second avionics bus, the second avionics bus being separate from the first field bus, the first avionics bus and the second field bus;
at least two secondary channels distinct from the at least two primary channels, the at least two secondary channels each comprising:
a secondary field interface, the secondary field interfaces being interconnected to the second field bus;
a third avionics interface compatible with the second avionics bus;
at least one secondary computer provided with a fourth avionics interface in communication via the second avionics bus with only one third avionics interface among the third avionics interfaces of the at least two secondary channels, the other third avionics interfaces being left free and separate from any avionics bus, said at least one secondary computer transmitting at least one secondary downlink avionics data frame via the second avionics bus;
said at least two secondary channels each comprising:
a secondary processing unit using said at least one secondary downlink avionics data frame;
at least one secondary conversion unit converting said at least one secondary downlink avionics data frame transmitted by said at least one secondary computer into at least one secondary downlink field data frame intended to be transmitted via the second field bus to each of the other secondary channels and, conversely, converting each secondary downlink field data frame received via the second field bus into a secondary downlink avionics data frame; and
a secondary memory storing a set of secondary downlink avionics data frames.

In addition, such an architecture, regardless of the simplex or duplex embodiment, may as previously comprise at least one piece of equipment, each piece of equipment comprising each of said at least two primary channels, or even also said at least two secondary channels.

Alternatively, the architecture may comprise at least two pieces of equipment, each piece of equipment comprising only one of said at least two primary channels, or even also only one of said at least two secondary channels.

Another object of the present disclosure is a vehicle, such as an aircraft, comprising an architecture for transmitting data within an avionics system fitted to the vehicle, the architecture comprising a first field bus and a first avionics bus.

The architecture is as described above. In addition, the architecture may be of various kinds and in particular may be implemented according to the first embodiment by being of the simplex type, or according to the second embodiment by being of the duplex type.

### BRIEF DESCRIPTION OF THE DRAWINGS

The disclosure and its advantages appear in greater detail from the following description of examples given by way of illustration with reference to the accompanying figures, wherein:

FIG. 1 is a diagram illustrating a data transmission architecture according to the prior art;

FIG. 2 is a diagram representing a data transmission architecture in accordance with the disclosure;

FIG. 3 is a logic diagram illustrating, in detail, a data transmission architecture according to the disclosure;

FIG. 4 is a first example of an architecture according to a first embodiment of a data transmission architecture according to the disclosure;

FIG. 5 is a second example of an architecture according to a first embodiment of a data transmission architecture according to the disclosure;

FIG. 6 is a third example of an architecture according to a first embodiment of a data transmission architecture according to the disclosure;

FIG. 7 is a first example of an architecture according to a second embodiment of a data transmission architecture according to the disclosure;

FIG. 8 is a second example of an architecture according to a second embodiment of a data transmission architecture according to the disclosure;

FIG. 9 is a third example of an architecture according to a second embodiment of a data transmission architecture according to the disclosure;

FIG. 10 is another logic diagram illustrating, in detail, a first embodiment of a data transmission architecture according to the disclosure;

FIG. 11 is another logic diagram illustrating in detail a second embodiment of a data transmission architecture according to the disclosure;

FIG. 12 is an example of architecture not covered by the disclosure; and

FIG. 13 shows another example of architecture not covered by the disclosure.

### DETAILED DESCRIPTION

Elements present in more than one of the figures are given the same references in each of them.

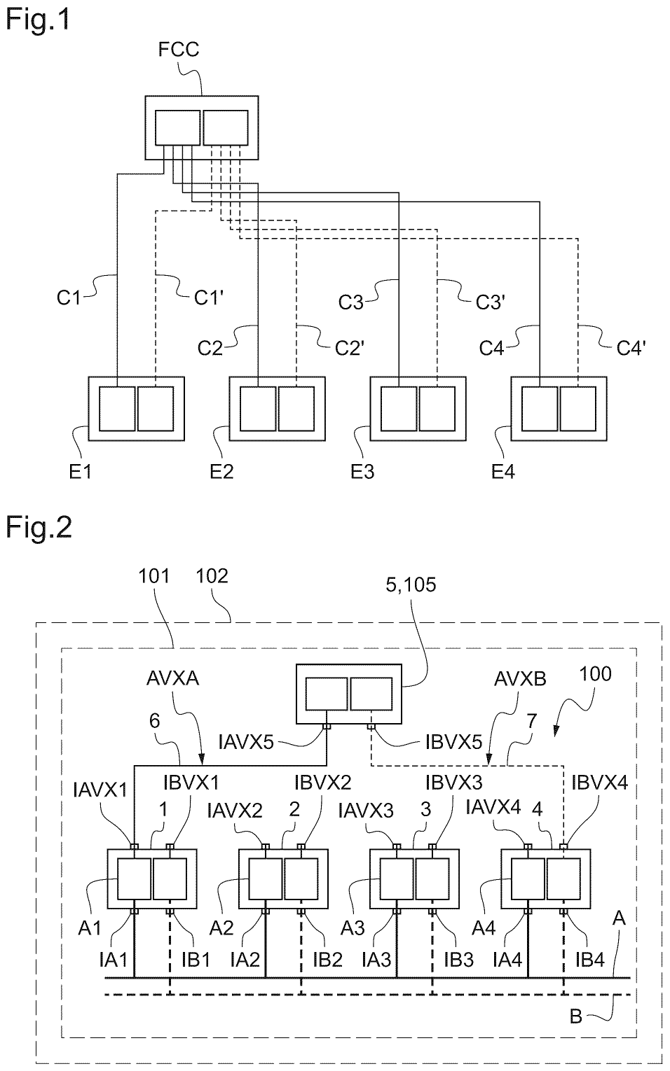

Conventionally, and as shown in FIG. 1, a data transmission architecture according to the prior art may comprise a plurality of pieces of equipment E1-E4 linked to a computer, such as a flight control computer, FCC.

In addition, each piece of equipment E1-E4 may comprise two channels. The FCC computer is then connected to each of the pieces of equipment E1-E4 by means of complex avionics buses having a plurality of connections and interfaces dedicated to these avionics' buses.

As shown, the example architecture of FIG. 1 then presents eight avionics interfaces arranged on the four pieces of equipment E1-E4 and eight avionics interfaces on the computer FCC.

As shown in FIG. 2, according to the disclosure, a data transmission architecture shared between four pieces of equipment of an avionics system and a computer can be simplified. Thus, the architecture 1 comprises a first network comprising a first field bus A and a first avionics bus AVX A. In addition, the architecture 1 may also comprise a second network comprising a second field bus B and a second avionics bus AVX B.

However, unlike the architecture in FIG. 1, the number of connections between the avionics interfaces is minimal. The number of avionics interfaces at the computer is also reduced to one per network.

Indeed, the first avionics bus AVX A comprises a single connection 6 linking only the piece of equipment 1 with a primary computer 5 and the second avionics bus AVX B comprises a single connection 7 linking the piece of equipment 4 with a secondary computer 105 that, as represented in FIG. 2, can be combined with the primary computer 5.

For this purpose, the architecture 1 comprises four primary channels A1-A4 each comprising a primary field interface IA1-IA4 connected to the first field bus A.

Similarly, the architecture 1 comprises four secondary channels B1-B4 each comprising a secondary field interface IB1-IB4 connected to the second field bus B.

Consequently, the pieces of equipment 1-4 can communicate with one another via the field buses A and B and only a first avionics interface IAVX1 compatible with the first avionics bus AVX A of the piece of equipment 1 can be connected to the computer 5 by means of the connection 6. The other first avionics interfaces IAVX2-IAVX4 are left free.

For this purpose, the primary computer 5 is provided with a second avionics interface IAVX5 in communication with the first avionics interface IAVX1 via the first avionics bus AVX A.

Similarly, only a third avionics interface IBVX4 compatible with the second avionics bus AVX B of the piece of equipment 4 can be connected to the secondary computer 105 by means of the connection 7. The other third avionics interfaces IBVX1-IBVX3 are left free.

The secondary computer 105 is provided with a fourth avionics interface IBVX5 in communication with the third avionics interface IBVX4 via the second avionics bus AVX B.

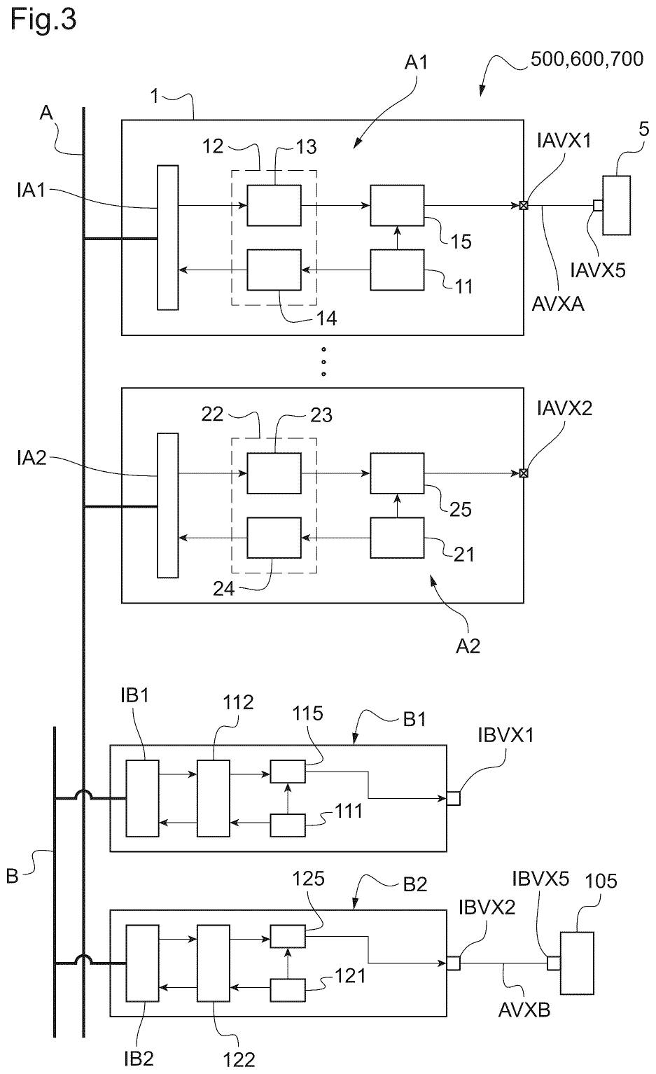

Furthermore, as shown in FIG. 3, each primary channel A1, A2 comprises a primary processing unit 11, 21 generating primary uplink avionics data frames.

Each primary channel A1, A2 also comprises at least one primary conversion unit 12, 22 that can comprise a first converter 14, 24 making it possible to convert each primary uplink avionics data frame generated by the primary processing unit 11, 21 into at least one primary uplink field data frame, intended to be transmitted, via the first field bus A, to all the other primary channels A1, A2 among said at least two primary channels A1, A2.

Each primary conversion unit 12, 22 may also comprise a second converter 13, 23 configured to convert each primary uplink field data frame received via the first field bus A into a primary uplink avionics data frame.

Each primary channel A1, A2 also comprises a primary memory 15, 25 storing a set of primary uplink avionics data frames comprising the primary uplink avionics data frames generated firstly by the primary processing unit 11, 21 of the primary channel A1, A2 concerned, and secondly by each of the primary processing units 12, 22 of said at least two primary channels A1, A2.

The set of primary uplink avionics data frames can then be inserted into a queue that is then transmitted to each first avionics interface IAVX1, IAVX2 compatible with the first avionics bus AVX A.

The primary computer 5 then receives the set of primary uplink avionics data frames via the first avionics bus AVX A. The primary computer 5 can then execute at least one critical function of the avionics system, using at least one of said primary uplink avionics data frames of this set of primary uplink avionics data frames.

Furthermore, each secondary channel B1, B2 comprises a secondary processing unit 111, 121 generating secondary uplink avionics data frames.

Each secondary channel B1, B2 also comprises at least one secondary conversion unit 112, 122 making it possible to convert each secondary uplink avionics data frame generated by the secondary processing unit 111, 121 into at least one secondary uplink field data frame intended to be transmitted via the second field bus B to all the other secondary channels B1, B2 among said at least two secondary channels B1, B2.

Each secondary conversion unit 112, 122 is configured to convert each secondary uplink field data frame received via the second field bus B into a secondary uplink avionics data frame.

Each secondary channel B1, B2 also comprises a secondary memory 115, 125 storing a set of secondary uplink avionics data frames comprising the secondary uplink avionics data frames generated firstly by the secondary processing unit 111, 121 of the secondary channel B1, B2 concerned and secondly by each of the secondary processing units 112, 122 of said at least two secondary channels B1, B2.

The set of secondary uplink avionics data frames can then be inserted into a queue that is then transmitted to each third avionics interface IBVX1, IBVX2 compatible with the second avionics bus AVX B.

Similarly, when the latter is present, the secondary computer 105, represented here in FIG. 3 as being separate from the primary computer 5, receives the set of secondary uplink avionics data frames via the second avionic bus AVX B and is configured to execute at least one critical function of the avionic system, using at least one of said secondary uplink avionics data frames of the set of said secondary uplink avionics data frames.

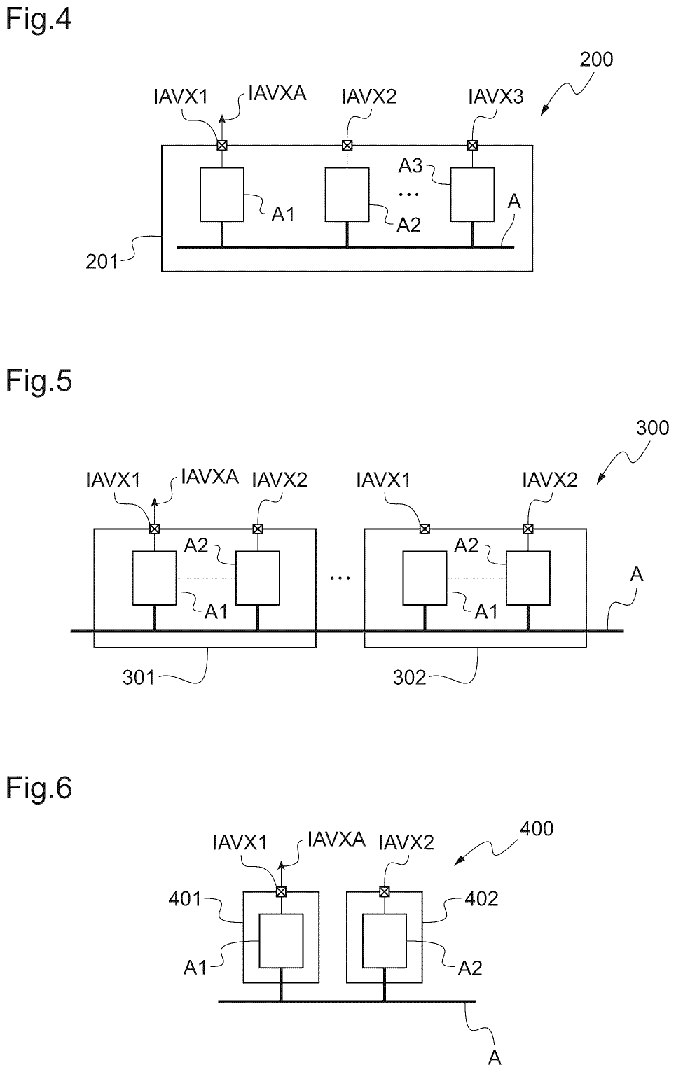

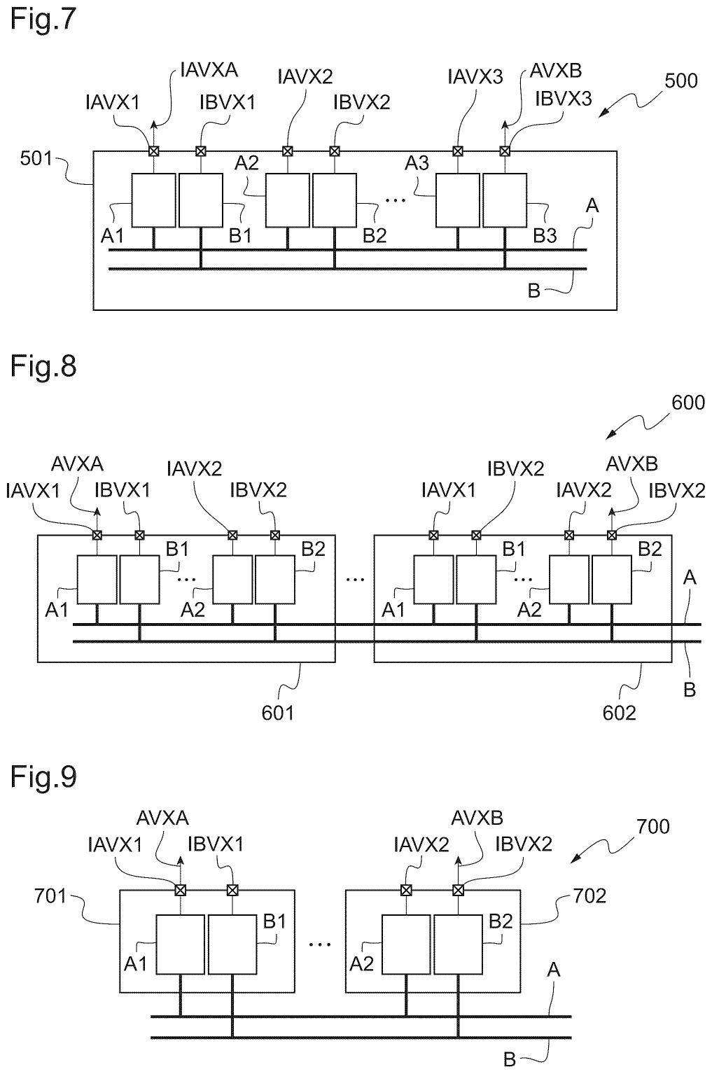

As shown in FIGS. 4 to 6, according to a first embodiment of the disclosure, such an architecture may be of the simplex type. Alternatively, as shown in FIGS. 7 to 9, according to a second embodiment of the disclosure, such an architecture may be of the duplex type.

Thus, according to a first example of the first embodiment shown in FIG. 4, the architecture 200 may comprise a single piece of equipment 201 comprising said at least two primary channels A1, A2, A3.

The architecture 200 thus comprises a single first avionics bus AVX A between the primary computer 5 (not shown) and the first avionics interface IAVX1 of the equipment 201 to transmit the set of primary uplink avionics data frames from the various primary channels A1, A2, A3. The other first avionics interfaces IAVX2, IAVX3 of the piece of equipment 201 are thus left free.

According to a second example of the first embodiment shown in FIG. 5, the architecture 300 may comprise at least two pieces of equipment 301, 302, each piece of equipment 301, 302 respectively comprising the at least two primary channels A1, A2.

As in the preceding example, the architecture 300 comprises a single first avionics bus AVX A between the primary computer 5 (not shown) and the first avionics interface IAVX1 arranged on a first piece of equipment 301 to transmit the set of primary uplink avionics data frames from the various primary channels A1, A2. The other first avionics interface IAVX2 of the first piece of equipment 301 is thus left free. Similarly, the other first avionics interfaces IAVX1, IAVX2 of a second piece of equipment 302 are thus left free.

According to a third example of the first embodiment shown in FIG. 6, with said at least two primary channels A1, A2 comprising a first primary channel A1 and a second primary channel A2, the architecture 400 may comprise a first piece of equipment 401 comprising exclusively the first primary channel A1 and a second piece of equipment 402 comprising exclusively the second primary channel A2.

Similarly, the architecture 400 comprises a single first avionics bus AVX A between the primary computer 5 (not shown) and the first avionics interface IAVX1 arranged on a first piece of equipment 401 to transmit the set of primary uplink avionics data frames from the various primary channels A1, A2. The other first avionics interface IAVX2 of the second piece of equipment 402 is left free.

According to a first example of the second embodiment shown in FIG. 7, the architecture 500 may comprise a single piece of equipment 501 comprising at least two primary channels A1, A2, A3 or even at least two secondary channels B1, B2, B3.

In this case, the architecture 500 comprises a single second avionics bus AVX B between the secondary computer 105 (not shown) and the third avionics interface IBVX3 of the piece of equipment 501 to transmit the set of secondary uplink avionics data frames coming from the various secondary channels B1, B2, B3.

The other third avionics interfaces IBVX1, IBVX2 of the piece of equipment 501 are thus left free.

Furthermore, according to a second example of the second embodiment shown in FIG. 8, the architecture 600 may comprise at least two pieces of equipment 601, 602, each piece of equipment 601, 602 comprising at least two primary channels A1, A2 and at least two secondary channels B1, B2.

As in the preceding example, the architecture 600 still comprises a single second avionics bus AVX B between the secondary computer 105 (not shown) and the third avionics interface IBVX2 arranged on a second piece of equipment 602 to transmit the set of secondary uplink avionics data frames from the various primary channels B1, B2. The other third avionics interface IBVX1 of the second piece of equipment 602 is thus left free. Similarly, the other third avionics interfaces IBVX1, IBVX2 of a first piece of equipment 601 are thus left free.

Finally, according to a third example of the second embodiment shown in FIG. 9, said at least two primary channels A1, A2 may comprise a first primary channel A1 and a second primary channel A2. Likewise, said at least two secondary channels B1, B2 may comprise a first secondary channel B1 and a second secondary channel B2. The architecture 700 may then comprise a first piece of equipment 701 comprising the first primary A1 and secondary B1 channels and a second piece of equipment 702 comprising the second primary A2 and secondary B2 channels.

The second avionics bus AVX B still comprises a single connection between the secondary computer 105 and the third avionics interface IBVX2 arranged on a second piece of equipment 702 to transmit the set of secondary uplink avionics data frames coming from the various secondary channels B1, B2. The other third avionics interface IBVX1 of the first piece of equipment 701 is left free.

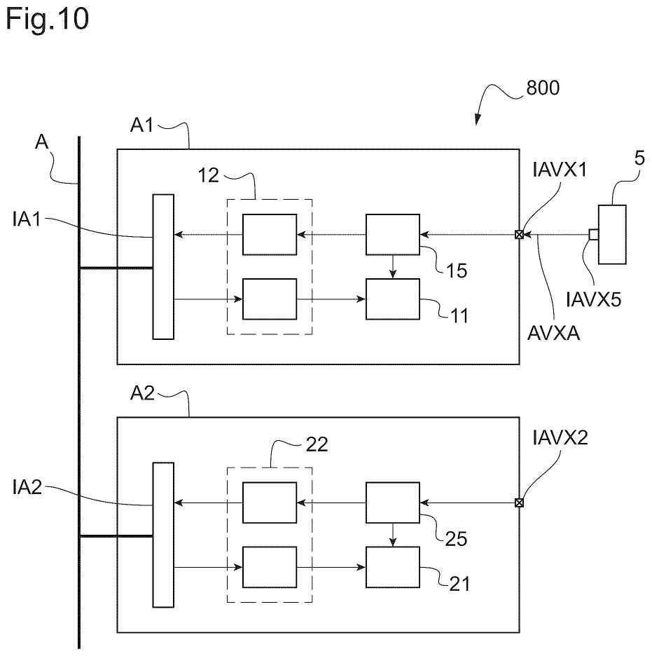

FIG. 10 illustrates a first embodiment of a simplex architecture 800 for transmitting data within an avionics system 101 fitted to a vehicle 102. Such an architecture 800 comprises, as before, a first field bus A and a first avionics bus AVX A distinct from each other.

Such an architecture 800 comprises at least two primary channels A1, A2 each comprising a primary field interface IA1, IA2, these field interfaces IA1, IA2 being interconnected to the first field bus A.

The at least two primary channels A1, A2 also each comprise a first avionics interface IAVX1, IAVX2 compatible with the first avionics bus AVX A.

The architecture 800 also comprises at least one primary computer 5 provided with a second avionics interface IAVX5 in communication via the first avionics bus AVX A with only one first avionics interface IAVX1 among the first avionics interfaces IAVX1, IAVX2 of said at least two primary channels A1, A2, the other first avionics interfaces IAVX2 being left free and separate from any avionics bus, said at least one primary computer 5 transmitting at least one primary downlink avionics data frame via the first avionics bus AVX A.

Therefore, the at least two primary channels A1, A2 also each comprise a primary processing unit 11, 21 using said at least one primary downlink avionics data frame.

The at least two primary channels A1, A2 also each comprise at least one primary conversion unit 12, 22 converting said at least one primary downlink avionics data frame transmitted by said at least one primary computer 5 into at least one primary downlink field data frame intended to be transmitted via the first field bus A to each of the other primary channels A2 and, conversely, converting each primary downlink field data frame received via the first field bus A into a primary downlink avionics data frame.

Finally, the at least two primary channels A1, A2 comprise a primary memory 15, 25 storing a set of primary downlink avionics data frames.

In addition, such an architecture 800 may, as previously for the architectures 200 and 300 shown in FIGS. 4 and 5, comprise at least one piece of equipment, each piece of equipment comprising each of said at least two primary channels A1, A2.

Alternatively, the architecture 800 may, as previously for the architecture 400 shown in FIG. 6, comprise at least two pieces of equipment, each piece of equipment comprising only one of said at least two primary channels A1, A2.

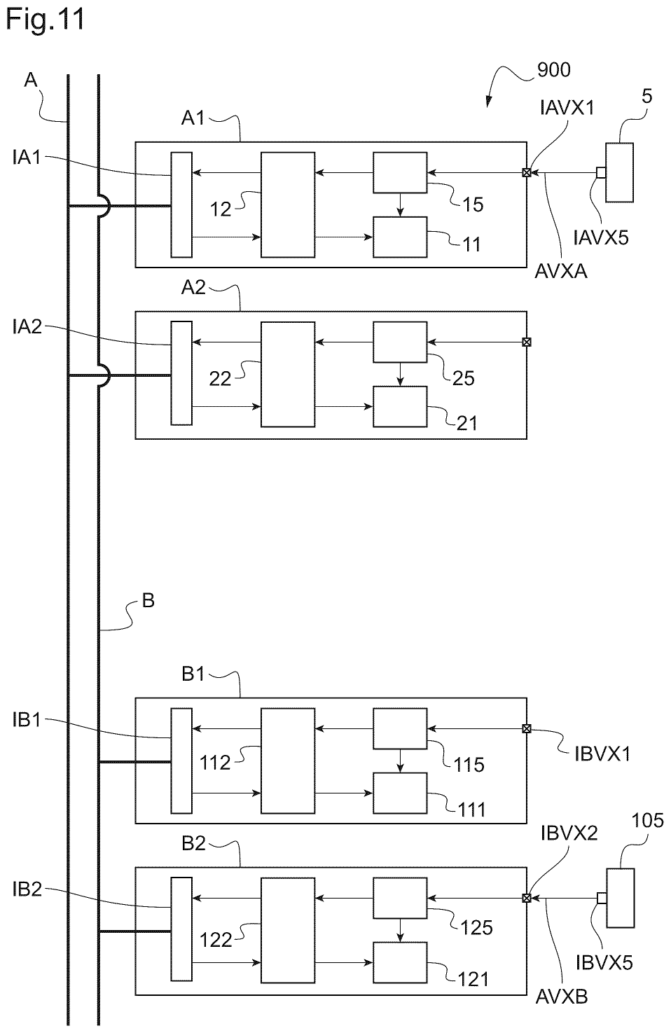

As with the architectures 500, 600 and 700, and as shown in FIG. 11 according to a second embodiment of the duplex type, the architecture 900 may have at least two secondary channels B1, B2 in addition to the at least two primary channels A1, A2.

In addition to the first field bus A, the architecture 900 comprises a second field bus B, the second field bus B being distinct from the first field bus A and the first avionics bus AVX A.

Similarly, each secondary channel B1, B2 comprises a secondary field interface IB1, IB2, the secondary field interfaces IB1, IB2 being interconnected to the second field bus B.

Moreover, each secondary channel B1, B2 comprises a third avionics interface IBVX1, IBVX2 compatible with the second avionics bus AVX B.

The architecture 900 also comprises a secondary computer 105, here shown as being separate from the primary computer 5, making it possible to transmit a set of secondary downlink avionics data frames via the second avionics bus AVX B. Such a secondary computer 105 may also be combined with the primary computer 5.

The secondary computer 105 is thus provided with a fourth avionics interface IBVX5 in communication, via the second avionics bus AVX B, with only one third avionics interface IBVX2 among the third avionics interfaces IBVX1, IBVX2 of the at least two secondary channels B1, B2.

Thus, the other third avionics interface IBVX1 is left free and separate from any avionics bus.

In addition, each of the secondary channels B1, B2 comprises a secondary processing unit 111, 121 using at least one secondary downlink avionics data frame and a secondary conversion unit 112, 122 configured to convert a secondary downlink avionics data frame transmitted by the secondary computer 105 into at least one secondary downlink field data frame to be transmitted via the second field bus B to each of the other secondary channels B1, B2 and, conversely, converting each secondary downlink field data frame received via the second field bus B into a secondary downlink avionics data frame.

Furthermore, each of the secondary channels B1, B2 comprises a secondary memory 115, 125 storing a set of several downstream secondary avionics data frames.

Furthermore, each secondary channel B1, B2 comprises a secondary processing unit 111, 121 generating secondary uplink avionics data frames.

In addition, such an architecture 900 may, as previously for the architectures 500 and 600 represented in FIGS. 7 and 8, comprise at least one piece of equipment, each piece of equipment comprising each of said at least two primary channels A1, A2 and said at least two secondary channels B1, B2.

Alternatively, the architecture 900 may, as previously for architecture 700 shown in FIG. 9, comprise at least two pieces of equipment, each piece of equipment comprising only one of said at least two primary channels A1, A2 and only one of said at least two secondary channels B1, B2.

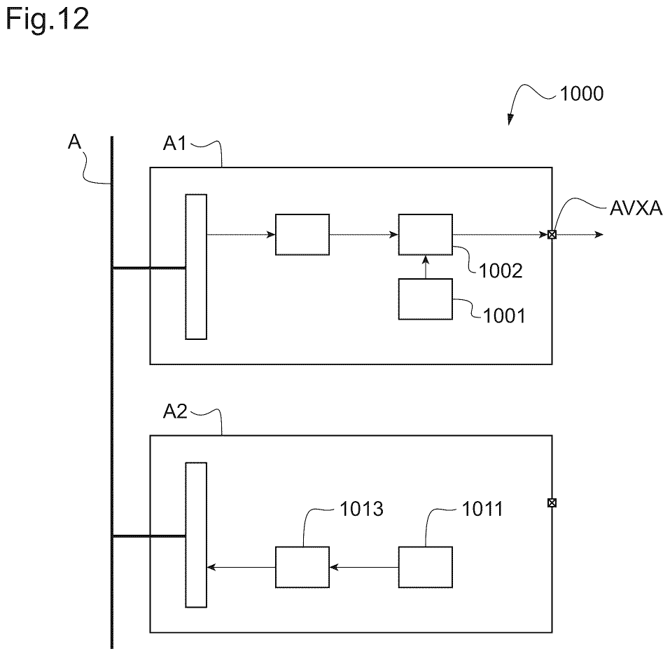

According to the unclaimed example of FIG. 12, the architecture 1000 may have at least two primary channels A1, A2.

However, each primary channel A2 that is not connected to the first avionics bus AVX A may comprise a primary processing unit 1011 for preparing primary uplink avionics data frames, and a primary conversion unit 1013 converting said at least one primary uplink avionics data frame prepared by the primary processing unit 1011 and then transmitted on the first field bus A.

One of the primary channels A1 that is connected to the first avionics bus AVX A may comprise a primary processing unit 1001 for preparing primary uplink avionics data frames and then storing the primary uplink avionics data frames in a primary memory 1002.

The primary channel A1 then receives the primary uplink avionics data frames from the other primary channels A2 via the first field bus A and also stores these primary uplink avionics data frames in the primary memory 1002.

The primary channel A1 then comprises a first avionics interface IAVX1 making it possible to transmit the primary uplink avionics data frames contained in the primary memory 1002 on the first avionics bus AVX A.

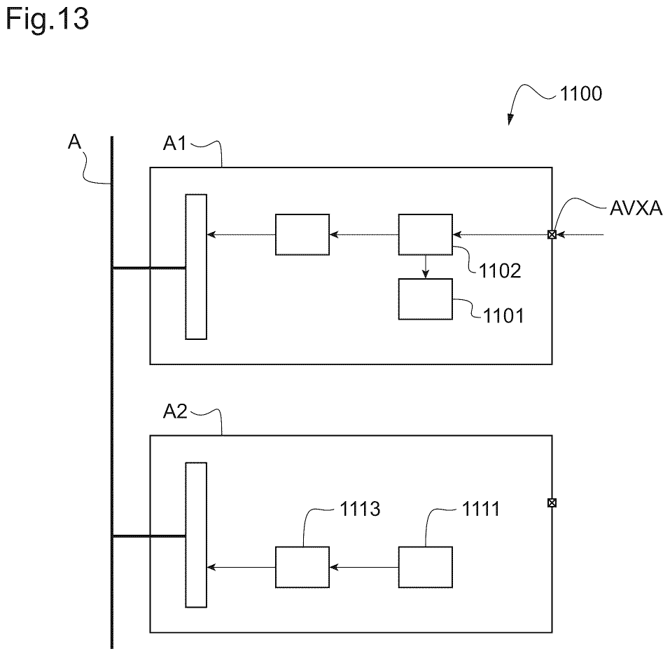

According to the unclaimed example of FIG. 13, the architecture 1100 may have at least two primary channels A1, A2.

However, each primary channel A2 that is not connected to the first avionics bus AVX A may comprise a primary conversion unit 1113 converting at least one primary downlink avionics data frame received via the first field bus A.

Each primary channel A2 also comprises a primary processing unit 1111 making it possible to use at least one primary downlink avionics data frame recovered via the field bus A.

One of the primary channels A1 that is connected to the first avionics bus AVX A may comprise an avionics interface for receiving avionics data frames and stores them in a primary memory 1102.

The primary channel A1 also comprises a primary processing unit 1101 for using the primary downlink avionics data frames intended for it.

The primary channel A1 comprises a primary conversion unit 1113 converting said at least one primary downlink avionics data frame stored in the primary memory 1102, and then transmits them by means of a field interface on the first field bus A if they are not intended for it.

Naturally, the present disclosure may be subjected to numerous variations as to its implementation. Although several embodiments are described above, it should readily be understood that it is not conceivable to identify exhaustively all the possible embodiments. It is of course possible to replace any of the means described with equivalent means without going beyond the ambit of the present disclosure.

What is claimed is:

1. An architecture for transmitting data within an avionics system fitted to a vehicle, the architecture comprising a first field bus and a first avionics bus, the first avionics bus being distinct from the first field bus,
wherein the architecture comprises:
at least two primary channels each comprising:
a primary field interface, the field interfaces being interconnected with the first field bus;
a first avionics interface compatible with the first avionics bus;
a primary processing unit generating primary uplink avionics data frames;
at least one primary conversion unit converting each primary uplink avionics data frame generated by the primary processing unit into at least one primary uplink field data frame intended to be transmitted via the first field bus to each of the other primary channels and, conversely, converting each primary uplink field data frame received via the first field bus into a primary uplink avionics data frame; and
a primary memory storing a set of primary uplink avionics data frames comprising primary uplink avionics data frames generated by each of the primary processing units of the at least two primary channels;
and, wherein the architecture comprises at least one primary computer provided with a second avionics interface in communication via the first avionics bus with only one first avionics interface among the first avionics interfaces of the at least two primary channels, the other first avionics interfaces being left free and separate from any avionics bus, the at least one primary computer receiving the set of primary uplink avionics data frames via the first avionics bus and being configured to execute at least one critical function of the avionics system, using at least one of the primary uplink avionics data frames of the set of primary uplink avionics data frames.

2. The architecture according to claim 1,
wherein the architecture comprises at least one piece of equipment comprising at least two primary channels among the at least two primary channels.

3. The architecture according to claim 1,
wherein the architecture comprises at least two pieces of equipment, each piece of equipment comprising only one of the at least two primary channels.

4. The architecture according to claim 1,
wherein the first field bus is selected from the group comprising a CAN bus, a CAN-FD bus, a LIN bus, a bus according to standard EIA-485, a bus according to standard EIA-422, a FlexRay bus, an Ethernet bus, an EtherCAT bus, a DeviceNet bus, a CANOpen bus, a CANOpen FD bus, a MODBUS bus, a PROFIBUS bus and a PROFINET bus.

5. The architecture according to claim 1,
wherein the first avionics bus is selected from the group comprising a bus according to standard STANAG 3910, a bus according to standard ARINC 429, a bus according to standard MIL-STD-1553B, a bus according to standard ARINC 629, a bus according to standard EIA-485, a bus according to standard EIA-422, an Ethernet bus and a bus according to standard ARINC-664.

6. The architecture according to claim 1,
wherein the architecture comprises:
a second field bus, the second field bus being distinct from the first field bus and the first avionics bus;
a second avionics bus, the second avionics bus being distinct from the first field bus, the first avionics bus and the second field bus;
at least two secondary channels distinct from the at least two primary channels, the at least two secondary channels each comprising:
a secondary field interface, the secondary field interfaces being interconnected with the second field bus;
a third avionics interface compatible with the second avionics bus;
a secondary processing unit generating secondary uplink avionics data frames;
at least one secondary conversion unit converting each secondary uplink avionics data frame generated by the secondary processing unit into at least one secondary uplink field data frame intended to be transmitted via the second field bus to each of the other secondary channels and, conversely, converting each secondary uplink field data frame received via the second field bus into a secondary uplink avionics data frame;
a secondary memory storing a set of secondary uplink avionics data frames comprising secondary uplink avionics data frames generated by each of the secondary processing units of the at least two secondary channels;
and, wherein the architecture comprises at least one secondary computer provided with a fourth avionics interface in communication via the second avionics bus with only one third avionics interface among the third avionics interfaces of the at least two secondary channels, the other third avionics interfaces being left free and separate from any avionics bus, the at least one secondary computer receiving the set of secondary uplink avionics data frames via the second avionics bus and being configured to execute at least one critical function of the avionics system, using at least one of the secondary uplink avionics data frames of the set of secondary uplink avionics data frames.

7. The architecture according to claim 6,
wherein the architecture comprises at least one piece of equipment, each piece of equipment comprising each of the at least two primary channels and the at least two secondary channels.

8. The architecture according to claim 6,
wherein the architecture comprises at least two pieces of equipment, each piece of equipment comprising only one of the at least two primary channels and only one of the at least two secondary channels.

9. The architecture according to claim 6,
wherein the second field bus is selected from the group comprising a CAN bus, a CAN-FD bus, a LIN bus, a bus according to standard EIA-485, a bus according to standard EIA-422, a FlexRay bus, an Ethernet bus, an EtherCAT bus, the DeviceNet bus, the CANOpen bus, the CANOpen FD bus, a MODBUS bus, a PROFIBUS bus and a PROFINET bus.

10. The architecture according to claim 6,
wherein the second avionics bus is selected from the group comprising a bus according to standard ARINC 429, a bus according to standard MIL-STD-1553B, a bus according to standard ARINC 629, a bus according to standard EIA-485, a bus according to standard EIA-422, an Ethernet bus and a bus according to standard ARINC-664.

11. A vehicle comprising the architecture for transmitting data within an avionics system with which the vehicle is fitted, the architecture comprising a first field bus and a first avionics bus,
wherein the architecture is according to claim 1.

12. An architecture for transmitting data within an avionics system fitted to a vehicle, the architecture comprising a first field bus and a first avionics bus, the first avionics bus being distinct from the first field bus,
wherein the architecture comprises:
at least two primary channels each comprising:
a primary field interface, the field interfaces being interconnected with the first field bus;
a first avionics interface compatible with the first avionics bus;
at least one primary computer provided with a second avionics interface in communication via the first avionics bus with only one first avionics interface among the first avionics interfaces of the at least two primary channels, the other first avionics interfaces being left free and separate from any avionics bus, the at least one primary computer transmitting at least one primary downlink avionics data frame via the first avionics bus;
the at least two primary channels each comprising:
a primary processing unit using the at least one primary downlink avionics data frame;
at least one primary conversion unit converting the at least one primary downlink avionics data frame transmitted by the at least one primary computer into at least one primary downlink field data frame intended to be transmitted via the first field bus to each of the other primary channels and, conversely, converting each primary downlink field data frame received via the first field bus into a primary downlink avionics data frame; and
a primary memory storing a set of primary downlink avionics data frames.

13. The architecture according to claim 12,
wherein the architecture comprises:
a second field bus, the second field bus being distinct from the first field bus and the first avionics bus;
a second avionics bus, the second avionics bus being distinct from the first field bus, the first avionics bus and the second field bus;
at least two secondary channels distinct from the at least two primary channels, the at least two secondary channels each comprising:
a secondary field interface, the secondary field interfaces being interconnected with the second field bus;
a third avionics interface compatible with the second avionics bus;
at least one secondary computer provided with a fourth avionics interface in communication via the second avionics bus with only one third avionics interface among the third avionics interfaces of the at least two secondary channels, the other third avionics interfaces being left free and separate from any avionics bus, the at least one secondary computer transmitting at least one secondary downlink avionics data frame via the second avionics bus;
the at least two secondary channels each comprising:
a secondary processing unit using the at least one secondary downlink avionics data frame;
at least one secondary conversion unit converting the at least one secondary downlink avionics data frame transmitted by the at least one secondary computer into at least one secondary downlink field data frame intended to be transmitted via the second field bus to each of the other secondary channels and, conversely, converting each secondary downlink field data frame received via the second field bus into a secondary downlink avionics data frame; and
a secondary memory storing a set of the secondary downlink avionics data frames.

14. A vehicle comprising the architecture for transmitting data within an avionics system with which the vehicle is fitted, the architecture comprising a first field bus and a first avionics bus,
wherein the architecture is according to claim 12.
